(19) United States
(12) Patent Application Publication
(10) Pub. No.: US 2017/0178380 A1
(43) Pub. Date: Jun. 22, 2017

(54) Real-Time Visualization Mechanism

(71) Applicant: Intel Corporation, Santa Clara, CA (US)

(72) Inventors: Emily N. Ivers, Hillsboro, OR (US); Kahyun Kim, Hillsboro, OR (US); Paul F. Sorenson, Hillsboro, OR (US); Brian R. Fairbanks, San Francisco, CA (US); Ronald T. Azuma, San Jose, CA (US); Jeremy Miossec-Backer, Hillsboro, OR (US)

(73) Assignee: Intel Corporation, Santa Clara, CA (US)

(21) Appl. No.: 14/976,317

(22) Filed: Dec. 21, 2015

(51) Int. Cl. G06T 13/40; G06F 1/16; G02B 27/01; H04L 29/08

(52) U.S. Cl. CPC G06T 13/40; H04L 67/12; G06F 1/163; G02B 27/017

(57) ABSTRACT

A method is described to facilitate real-time visualization. The method includes receiving sensory data from one or more wearable devices, determining a real-time body position of a use based on the sensory data, generating an image of the user based on the real-time body position and displaying the image of the user at an optical head-mounted display computing device.

### FIELD

Embodiments described herein generally relate to wearable computing. More particularly, embodiments relate to visualization based wearable based body-worn sensor networks.

### BACKGROUND

Modern clothing and other wearable accessories may incorporate computing or other advanced electronic technologies. Such computing and/or advanced electronic technologies may be incorporated for various functional reasons or may be incorporated for purely aesthetic reasons. Such clothing and other wearable accessories are generally referred to as “wearable technology” or “wearable computing devices.”

Wearable devices may allow users to leverage the power of small sensors worn on the body to measure movement, position, and breathing. These sensors, which typically form a body-worn sensor network, may be located in various places on the body embedded in clothing, worn on bands and jewelry, and even applied to the body with adhesive. Visualizing and interacting in real time with the body-worn sensor network and the data it produces represents a more challenging problem since these small sensors often cannot use displays or other forms of input/output. Solutions most often involve using a smartphone to view information. However such solutions remove the user out of the moment and interrupt practice due to the necessity of having to remove a phone or tablet and view the display in most cases.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates one embodiment of a real-time visualization mechanism at a computing device.

FIG. 2 illustrates one embodiment of a real-time visualization mechanism.

FIG. 3 illustrates one embodiment of wearable computing devices implemented by a real-time visualization mechanism.

FIG. 4 illustrates one embodiment of images displayed by a real-time visualization mechanism.

FIG. 5 is a flow diagram illustrating one embodiment of a process performed by a real-time visualization mechanism.

FIG. 6 illustrates computer system suitable for implementing embodiments of the present disclosure.

### DETAILED DESCRIPTION

Embodiments may be embodied in systems, apparatuses, and methods for real-time visualization, as described below. In the description, numerous specific details, such as component and system configurations, may be set forth in order to provide a more thorough understanding of the present invention. In other instances, well-known structures, circuits, and the like have not been shown in detail, to avoid unnecessarily obscuring the present invention.

Embodiments provide for a real-time visualization mechanism to utilize an optical head-mounted display system to interact with user wearable computing devices operating as a body-worn sensor network. In such embodiments the interaction enables a user to visualize their own movement during an activity in which body position, form, and movement is important. Thus, the user may visualize performance of the activity within an environment while hands remain free. Activities may include yoga, weightlifting, Pilates, baseball (hitting and pitching), dance, golf, etc.

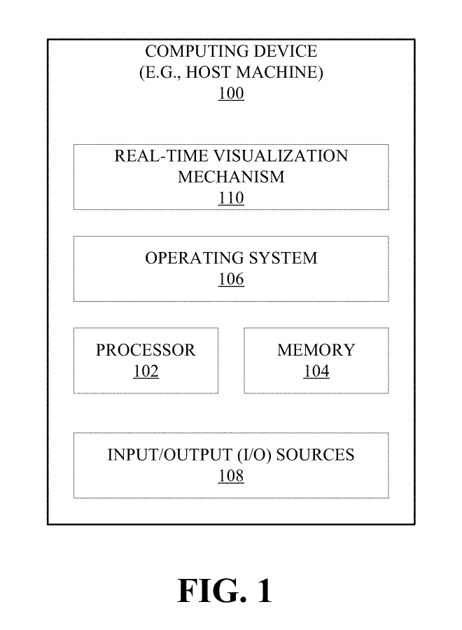

FIG. 1 illustrates one embodiment of a real-time visualization mechanism 110 at a computing device 100. In one embodiment, computing device 100 serves as a host machine for hosting real-time visualization mechanism (“visualization mechanism”) 110 that includes a combination of any number and type of components for detecting stimuli and visualization at computing devices, such as computing device 100. In one embodiment, computing device 100 includes a wearable computing device (or wearable device). In a further embodiment, computing device 100 is an optical head-mounted display (OHMD) that reflects projected images, as well as allows a user to view objects through the OHMD. Thus, implementation of visualization mechanism 110 results in computing device 100 being an assistive device to provide real-time visualization to a wearer of computing device 100.

In other embodiments, real-time visualization operations may be performed at a computing device 100 including large computing systems, such as mobile computing devices, such as cellular phones including smartphones, tablet computers), laptop computers (e.g., notebook, netbook, Ultrabook™, etc.). In yet other embodiments, computing device 100 may include server computers, desktop computers, etc., and may further include set-top boxes (e.g., Internet-based cable television set-top boxes, etc.), global positioning system (GPS)-based devices, etc.

Computing device 100 may include an operating system (OS) 106 serving as an interface between hardware and/or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc.

Throughout this document, a use of terms such as “logic”, “component”, “module”, “framework”, “engine”, “point”, and the like, may be referenced interchangeably and include, by way of example, software, hardware, and/or any combination of software and hardware, such as firmware. Further, any use of a particular brand, word, term, phrase, name, and/or acronym, should not be read to limit embodiments to software or devices that carry that label in products or in literature external to this document.

It is contemplated that any number and type of components may be added to and/or removed from real-time visualization mechanism 110 to facilitate various embodiments including adding, removing, and/or enhancing certain features. For brevity, clarity, and ease of understanding of real-time visualization mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

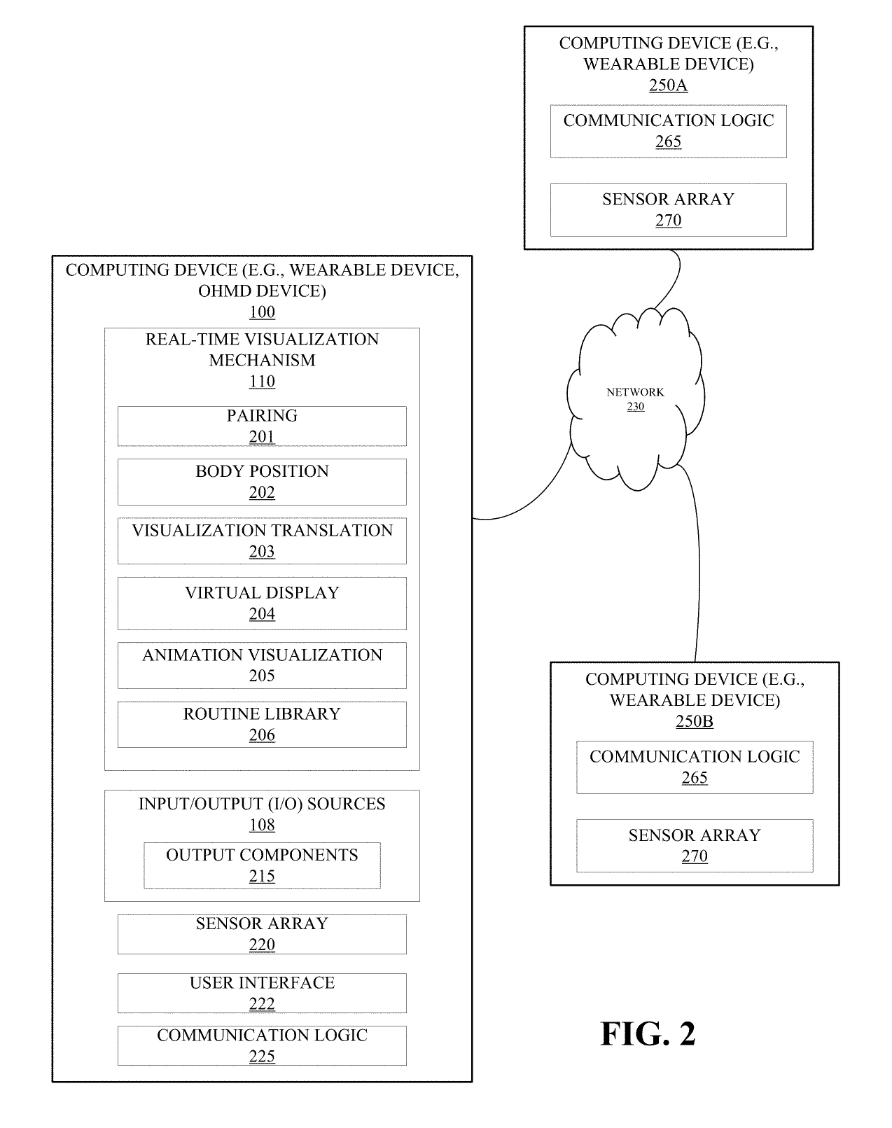

FIG. 2 illustrates a real-time visualization mechanism 110 employed at computing device 100. In one embodiment, real-time visualization mechanism 110 may include any number and type of components, such as: pairing module 201, body position module 202, visualization translation module 203, virtual display 204, animation visualization 205 and routine library 206. In one embodiment, pairing module 201 is implemented to pair computing device 100 with one or more other computing devices 250 in a network 230.

In such an embodiment, an OHMD computing device 100 is in communication with one or more computing devices 250 (e.g., computing devices 250A and 250B) implemented as other wearable devices over network 230. Computing device 100 and computing devices 250 include communication logic 225 and communication logic 265 to facilitate dynamic communication and compatibility between various computing devices, such as computing device 100 and computing devices 250, as well as storage devices, databases and/or data sources. According to one embodiment, network 230 is a Body-worn sensor network implemented via a proximity network (e.g., Bluetooth, Bluetooth low energy (BLE), Wi-Fi proximity, Radio Frequency Identification (RFID), Near Field Communication (NFC), etc.).

In one embodiment, computing devices 250 include sensor array 270 that receives sensory data implemented at real-time visualization mechanism 110. Sensor array 270 may include an image capturing device, such as a camera. Such a device may include various components, such as (but are not limited to) an optics assembly, an image sensor, an image/video encoder, etc., that may be implemented in any combination of hardware and/or software. Further, sensor array 220 may include other types of sensing components, such as context-aware sensors (e.g., myoelectric sensors, temperature sensors, facial expression and feature measurement sensors working with one or more cameras, environment sensors (such as to sense background colors, lights, etc.), biometric sensors (such as to detect fingerprints, facial points or features, etc.), position an/or GPS sensors, and the like. Computing device 100 may also include sensor array 220, which may be similar to or the same as sensor array 270 of computing devices 250, to receive sensory data.

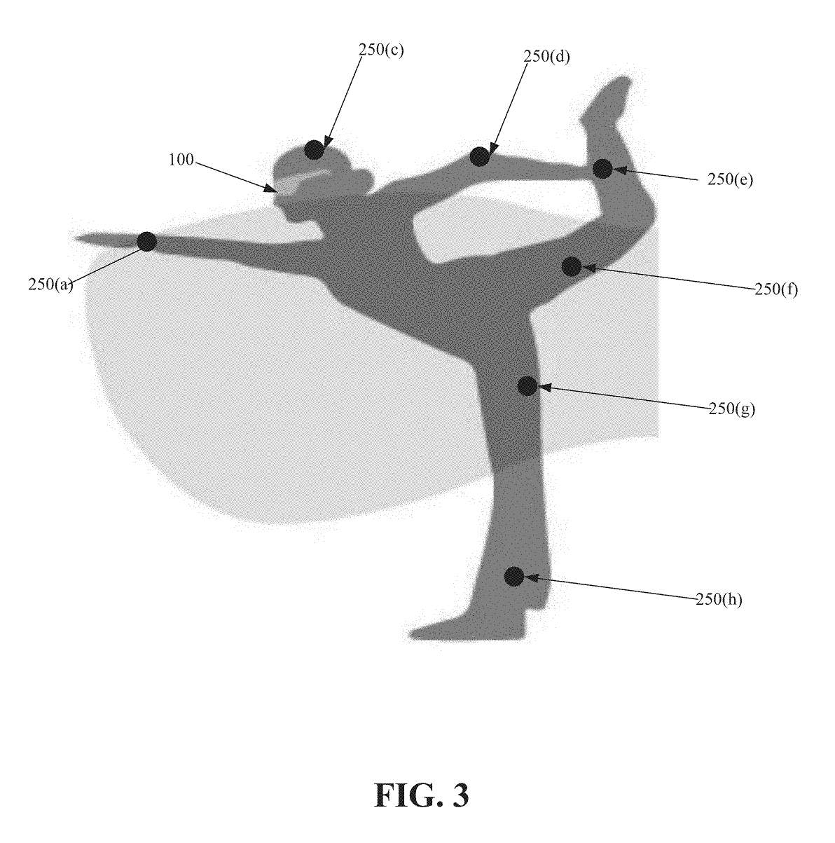

FIG. 3 illustrates one embodiment of wearable devices from which real-time visualization mechanism 110 may receive data. As shown in FIG. 3, devices 250(a)-250(h) may be worn on a user's body (e.g., head, chest, wrist, waist and foot, etc.). In such embodiments, data is transmitted from each device 310 to context sensing engine real-time visualization mechanism 110. As discussed above, devices 250 each include a sensory array 270 of sensors. In one embodiment, the sensors are applied to locations of a user's body to detect movement and positions relative to one another. In such an embodiment, devices 310 are applied directly to the user's body (e.g., ankles, knees, back, shoulders, etc.).

Referring back to FIG. 2, body position module 202 receives the sensory data from devices 250 within network 230 and determines a real-time body position of the user. According to one embodiment, body position module 202 builds a relative model of the user's body and limbs based on the received sensor data. Visualization module 203 translates the data into a visualization of the body for display at computing device 100. In one embodiment, output components 215 include a head-mounted display (HMD) for at least one of virtual reality (VR) and augmented reality (AR), etc. In such an embodiment, the HMD comprises a retinal scan display (RSD), or other projection-display technology (e.g., laser emitting diodes (LED) and non-raster based direct projection systems), that draws a display directly onto the retina of the user's eye.

In further embodiments, output components 215 may include (without limitation) one or more of light sources, display devices and/or screens, audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, high-resolution displays, high-dynamic range displays, and multi-view displays.

Virtual display module 204 receives the translated body position data and generates a corresponding image of the user for display to the user via the RSD. In one embodiment, the relative position of the sensors attached to the major joints and extremities of the body is wirelessly transmitted to processor 102 at computing device 100 or to an external device (such as smartphone). Subsequently, processor 102 interprets (via algorithms or other intelligent processing) the relative sensor positions and creates a unified ‘body model’ that shows the wearer's posture and sends it to the virtual display module 204.

Animation visualization module 205 receives update data from computing devices 250 via network 320 resulting from a change in the user's body position. In one embodiment, animation module 205 creates an animation visualization of the wearer's body position, including the relative positions of the sensor-monitored joints, limbs and head, monitoring and updating the visualized body-position over time as the data from the sensor network changes over time.

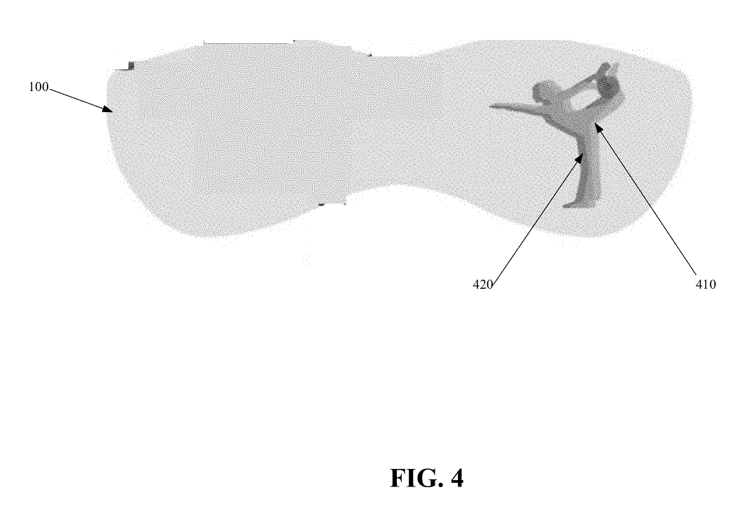

Routine library 206 stores preloaded activity routines that include ideal positions for the activity. For instance, routine library 206 may be pre-loaded with a yoga routine that includes an ideal body position for each yoga pose. According to one embodiment, an image of an activity routine may also be displayed via the RSD. In such an embodiment, the activity routine image is displayed alongside the user's body position, or superimposed on the body-visualization, highlighting areas where the wearer's body position does not match that of the model-configuration, enabling the user to correct their form by matching their body animation to the model-pose, or position.. FIG. 4 illustrates one embodiment of a user body image 410 alongside an activity routine image 420.

Computing device 100 also includes user interface 222 that provides for user interaction with computing device 100. In one embodiment, user interface 222 enables a user to interact via gestures and/or audio commands in order to provide feedback to visualization mechanism 110. It is contemplated that any number and type of components 201-225 of visualization mechanism 110 may not necessarily be at a single computing device and may be allocated among or distributed between any number and type of computing devices, including computing devices 100, 250. Further examples include microprocessors, graphics processors or engines, microcontrollers, application specific integrated circuits (ASICs), and so forth. Embodiments, however, are not limited to these examples.

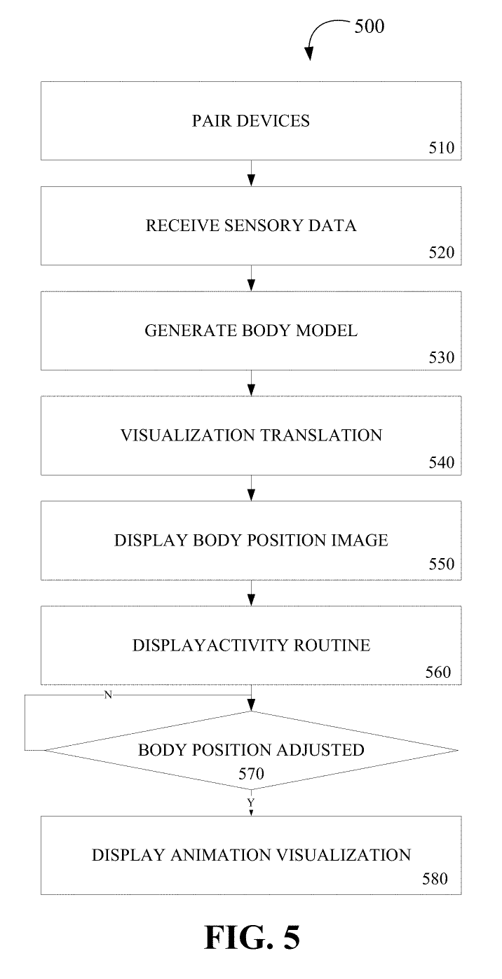

FIG. 5 is a flow diagram illustrating one embodiment of a process 400 to perform real-time visualization. Process 400 may be performed by processing logic that may comprise hardware (e.g., circuitry, dedicated logic, programmable logic, etc.), software (such as instructions run on a processing device), or a combination thereof. In one embodiment, method 400 may be performed by real-time visualization mechanism 110. The processes of method 400 are illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-4 are not discussed or repeated here.

At processing block 510, real-time visualization mechanism 110 at computing device 100 is paired with network 230 computing devices 250. At some time later the user begins to perform the displayed routine. At processing block 520, real-time visualization mechanism 110 receives sensory data from sensors at computing devices 250. At processing block 530, a relative model of the user's body and limbs is generated based on the received sensor data.

At processing block 540, a visualization translation of the model is performed. At processing block 550, a body position image is displayed. At processing block 560, an activity routine (e.g., model yoga pose) is displayed. At decision block 570, a determination is made as to whether the user has changed body position in response to the displayed body position image based on updated sensory data. An animation visualization of the body position adjustment is played upon a determination that user has changed body position, processing block 580. Otherwise control is returned to decision block 570 for a further determination of whether body position has been adjusted.

As shown in the above-description, sensor data is used to modify a body visualization in real time while a model pose is also visible. Computed differences between the users' body and the model position is also displayed on the visualization. As the user adjusts their body position it is reflected in the visualization. As a result, the visualization reflects the match when the user's body position matches the model.

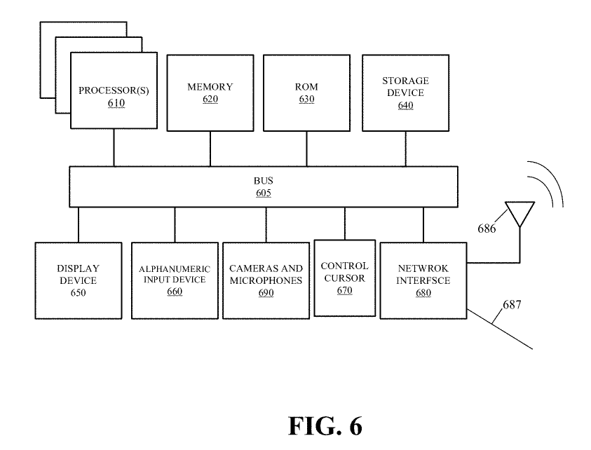

FIG. 6 illustrates a computer system suitable for implementing embodiments of the present disclosure. Computing system 600 includes bus 605 (or, for example, a link, an interconnect, or another type of communication device or interface to communicate information) and processor 610 coupled to bus 605 that may process information. While computing system 600 is illustrated with a single processor, electronic system 600 and may include multiple processors and/or co-processors, such as one or more of central processors, graphics processors, and physics processors, etc. Computing system 600 may further include random access memory (RAM) or other dynamic storage device 620 (referred to as main memory), coupled to bus 605 and may store information and instructions that may be executed by processor 610. Main memory 620 may also be used to store temporary variables or other intermediate information during execution of instructions by processor 610.

Computing system 600 may also include read only memory (ROM) and/or other storage device 630 coupled to bus 605 that may store static information and instructions for processor 610. Date storage device 640 may be coupled to bus 605 to store information and instructions. Date storage device 640, such as magnetic disk or optical disc and corresponding drive may be coupled to computing system 600.

Computing system 600 may also be coupled via bus 605 to display device 650, such as a cathode ray tube (CRT), liquid crystal display (LCD) or Organic Light Emitting Diode (OLED) array, to display information to a user via a display other than that on the worn-device. User input device 660, including alphanumeric and other keys, may be coupled to bus 605 to communicate information and command selections to processor 610. Another type of user input device 660 is cursor control 670, such as a mouse, a trackball, a touchscreen, a touchpad, or cursor direction keys to communicate direction information and command selections to processor 610 and to control cursor movement on display 650. Camera and microphone arrays 690 of computer system 600 may be coupled to bus 605 to observe gestures, record audio and video and to receive and transmit visual and audio commands

Computing system 600 may further include network interface(s) 680 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 680 may include, for example, a wireless network interface having antenna 685, which may represent one or more antenna(e). Network interface(s) 680 may also include, for example, a wired network interface to communicate with remote devices via network cable 687, which may be, for example, an Ethernet cable, a coaxial cable, a fiber optic cable, a serial cable, or a parallel cable.

Network interface(s) 680 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 680 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 680 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 600 may vary from implementation to implementation depending upon numerous factors, such as price constraints, performance requirements, technological improvements, or other circumstances. Examples of the electronic device or computer system 500 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate real-time visualization comprising one or more wearable computing devices having an array of sensors and an optical head-mounted display (OHMD) computing device, communicatively coupled to the array of sensors, including a body position module to receive sensory data from the array of sensors to determine a real-time body position of a user, and a virtual display module to generate an image of the user based on the real-time body position and a display device to display the image of the user.

Example 2 includes the subject matter of Example 1, wherein the body position module builds a relative model of the user based on the received sensor data.

Example 3 includes the subject matter of Examples 1 and 2, wherein the OHMD computing device further comprises an animation visualization module to receive update data from the array of sensors resulting from a change in the user body position and to update visualization of the body image based on the change in the user body position.

Example 4 includes the subject matter of Examples 1-3, wherein the OHMD computing device further comprises a routine library to store preloaded activity routines.

Example 5 includes the subject matter of Examples 1-4, wherein an activity routine is displayed at the display device with the image of the user.

Example 6 includes the subject matter of Examples 1-5, wherein the OHMD computing device further comprises a visualization translation module to translate the sensory data into body visualization data prior to generating the image of the user.

Example 7 includes the subject matter of Examples 1-6, wherein the display comprises a retinal scan display (RSD).

Example 8 includes the subject matter of Examples 1-7, wherein the one or more wearable computing devices comprise a body-worn sensor network.

Some embodiments pertain to Example 9 that includes a method to facilitate real-time visualization comprising receiving sensory data from one or more wearable devices, determining a real-time body position of a use based on the sensory data, generating an image of the user based on the real-time body position and displaying the image of the user at an optical head-mounted display (OHMD) computing device.

Example 10 includes the subject matter of Example 9, wherein determining the real-time body position comprises generating a relative model of the user.

Example 11 includes the subject matter of Examples 9 and 10, further comprising translating the sensory data into body visualization data prior to generating the image of the user.

Example 12 includes the subject matter of Examples 9-11, further comprising displaying an activity routine.

Example 13 includes the subject matter of Examples 9-12, further comprising determining whether updated sensory data has been received indicating an adjustment to the user body position.

Example 14 includes the subject matter of Examples 9-13, further comprising displaying an update visualization of the user body image upon a determination that updated sensory data has been received indicating an adjustment to the user body position.

Example 15 includes the subject matter of Examples 9-14, wherein the adjustment to the user body position is in response to displaying the activity routine.

Example 16 includes the subject matter of Examples 9-15, wherein the one or more wearable computing devices comprise a body-worn sensor network.

Some embodiments pertain to Example 17 that includes at least one machine-readable medium comprising a plurality of instructions that in response to being executed on one or more computing devices, causes the computing devices to receive sensory data from one or more wearable devices, determine a real-time body position of a use based on the sensory data, generate an image of the user based on the real-time body position and display the image of the user at an optical head-mounted display (OHMD) computing device.

Example 18 includes the subject matter of Example 17, wherein determining the real-time body position comprises generating a relative model of the user.

Example 19 includes the subject matter of Examples 17 and 18, comprising a plurality of instructions that in response to being executed on a computing device, further causes the computing devices to translate the sensory data into body visualization data prior to generating the image of the user.

Example 20 includes the subject matter of Examples 17-19, comprising a plurality of instructions that in response to being executed on a computing device, further causes the computing devices to display an activity routine.

Example 21 includes the subject matter of Examples 17-20, comprising a plurality of instructions that in response to being executed on a computing device, further causes the computing devices to determine whether updated sensory data has been received indicating an adjustment to the user body position.

Example 22 includes the subject matter of Examples 17-21, comprising a plurality of instructions that in response to being executed on a computing device, further causes the computing devices to display an update visualization of the user body image upon a determination that updated sensory data has been received indicating an adjustment to the user body position.

Some embodiments pertain to Example 23 that includes a body-worn sensor network comprising a first wearable computing device located at a first body position of a user and a second wearable computing device located at a second body position of the user, and an optical head-mounted display (OHMD) computing device, communicatively coupled to the body-worn sensor network including a body position module to receive sensory data from the first and second wearable computing devices to determine a real-time body position of a user, and a virtual display module to generate an image of the user based on the real-time body position and a display device to display the image of the user.

Example 24 includes the subject matter of Example 23, wherein the OHMD computing device further comprises an animation visualization module to receive update data from the array of sensors resulting from a change in the user body position and to update visualization of the body image based on the change in the user body position.

Example 25 includes the subject matter of Examples 23 and 24, wherein the OHMD computing device further comprises a routine library to store preloaded activity routines.

Some embodiments pertain to Example 26 that includes at least one machine-readable medium comprising a plurality of instructions that in response to being executed on one or more computing devices, causes the computing devices to perform the methods of claims 9-16.

Some embodiments pertain to Example 27 that includes a system to facilitate real-time visualization comprising means for receiving sensory data from one or more wearable devices, means for determining a real-time body position of a use based on the sensory data, means for generating an image of the user based on the real-time body position and means for displaying the image of the user at an optical head-mounted display (OHMD) computing device.

Example 28 includes the subject matter of Example 27, wherein determining the real-time body position comprises generating a relative model of the user.

Example 29 includes the subject matter of Examples 27 and 28, further comprising means for translating the sensory data into body visualization data prior to generating the image of the user.

Example 30 includes the subject matter of Examples 27-29, further comprising means for displaying an activity routine.

Example 31 includes the subject matter of Examples 27-30, further comprising means for determining whether updated sensory data has been received indicating an adjustment to the user body position.

Example 32 includes the subject matter of Examples 27-31, further comprising means for displaying an update visualization of the user body image upon a determination that updated sensory data has been received indicating an adjustment to the user body position.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagrams in this document need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1. An apparatus to facilitate real-time visualization comprising:
a body-worn sensor network including one or more wearable computing devices including an array of sensors; and
an optical head-mounted display computing device, communicatively coupled to the array of sensors, including:
a body position module to receive sensory data from the array of sensors to determine a real-time body position of a user and generate a relative model of the user based on the received sensor data; and
a virtual display module to generate an image of the user based on the real-time body position; and
a display device to display the image of the user.

2. (canceled)

3. The apparatus of claim 1, wherein the optical head-mounted display computing device further comprises an animation visualization module to receive update data from the array of sensors resulting from a change in the user body position and to update visualization of the body image based on the change in the user body position.

4. The apparatus of claim 3, wherein the optical head-mounted display computing device further comprises a routine library to store preloaded activity routines.

5. The apparatus of claim 4, wherein an activity routine is displayed at the display device with the image of the user.

6. The apparatus of claim 4, wherein the optical head-mounted display computing device further comprises a visualization translation module to translate the sensory data into body visualization data prior to generating the image of the user.

7. The apparatus of claim 1, wherein the display comprises a retinal scan display.

8. (canceled)

9. A method to facilitate real-time visualization comprising:
receiving sensory data from one or more wearable devices included in a body-worn sensor network;
determining a real-time body position of a user based on the sensory data;
generate a relative model of the user based on the received sensor data;
generating an image of the user based on the real-time body position; and
displaying the image of the user at an optical head-mounted display computing device.

10. (canceled)

11. The method of claim 9, further comprising translating the sensory data into body visualization data prior to generating the image of the user.

12. The method of claim 10, further comprising displaying an activity routine.

13. The method of claim 12, further comprising determining whether updated sensory data has been received indicating an adjustment to the user body position.

14. The method of claim 13, further comprising displaying an update visualization of the user body image upon a determination that updated sensory data has been received indicating an adjustment to the user body position.

15. The method of claim 13, wherein the adjustment to the user body position is in response to displaying the activity routine.

16. The method of claim 9, wherein the one or more wearable computing devices comprise a body-worn sensor network.

17. At least one non-transitory machine-readable medium comprising a plurality of instructions that in response to being executed on one or more computing devices, causes the computing devices to:
receive sensory data from one or more wearable devices included in a body-worn sensor network;
determine a real-time body position of a use based on the sensory data;
generate a relative model of the user based on the received sensor data;
generate an image of the user based on the real-time body position; and
display the image of the user at an optical head-mounted display computing device.

18. (canceled)

19. The at least one machine-readable medium of claim 17, comprising a plurality of instructions that in response to being executed on a computing device, further causes the computing devices to translate the sensory data into body visualization data prior to generating the image of the user.

20. The at least one machine-readable medium of claim 18, comprising a plurality of instructions that in response to being executed on a computing device, further causes the computing devices to display an activity routine.

21. The at least one machine-readable medium of claim 20, comprising a plurality of instructions that in response to being executed on a computing device, further causes the computing devices to determine whether updated sensory data has been received indicating an adjustment to the user body position.

22. The at least one machine-readable medium of claim 21, comprising a plurality of instructions that in response to being executed on a computing device, further causes the computing devices to display an update visualization of the user body image upon a determination that updated sensory data has been received indicating an adjustment to the user body position.

23. A system to facilitate real-time visualization comprising:
a body-worn sensor network comprising:
a first wearable computing device located at a first body position of a user;
a second wearable computing device located at a second body position of the user;
an optical head-mounted display computing device, communicatively coupled to the body-worn sensor network, including:
a body position module to receive sensory data from the first and second wearable computing devices to determine a real-time body position of a user and generate a relative model of the user based on the received sensor data; and
a virtual display module to generate an image of the user based on the real-time body position; and
a display device to display the image of the user.

24. The system of claim 23, wherein the optical head-mounted display computing device further comprises an animation visualization module to receive update data from the array of sensors resulting from a change in the user body position and to update visualization of the body image based on the change in the user body position.

25. The system of claim 24, wherein the optical head-mounted display computing device further comprises a routine library to store preloaded activity routines.
